(19) United States
(12) Patent Application Publication
(10) Pub. No.: US 2011/0285932 A1
(43) Pub. Date: Nov. 24, 2011

(54) LCD SCREEN PROTECTOR FOR LCD DEVICES

(76) Inventor: Han Jong PARK, Daegu-City (KR)

(21) Appl. No.: 12/949,177

(22) Filed: Nov. 18, 2010

(30) Foreign Application Priority Data
May 24, 2010 (KR) 20-2010-0005350

(51) Int. Cl. G02F 1/1333

(52) U.S. Cl. 349/56

(57) ABSTRACT

An LCD screen protector for LCD devices, which is made of thin, tempered glass or reinforced plastics with great strength, strongly adhered on the surface of an LCD device to protect the LCD device from external shocks. The LCD screen protector includes a protective plate made of tempered glass or reinforced plastics with good anti-bendability and a ring-shaped band with elasticity protrudingly formed on an outer circumference of the protective plate.

### BACKGROUND OF THE INVENTION

1. Field of the Invention

The present invention relates to an LCD screen protector for LCD devices, and more particularly, to an LCD screen protector for LCD devices, which is made of thin, tempered glass or reinforced plastics with surface strength and bending strength, strongly adhered on the surface of an LCD device to protect the LCD device from external shocks, and easily removable.

2. Background Art

In general, LCD (Liquid Crystal Display) devices, such as mobile phones, electronic dictionaries, navigations, computer monitors, televisions, and so on, have been used in various fields. Recently, in case of handheld devices, such as mobile phones and electronic dictionaries, in order to reduce a size of the display device and expand a visible screen, using touch screen LCD devices for inputting and outputting commands by directly touching a screen of the LCD device is a growing trend.

As described above, in case of the handheld products, the display device is frequently damaged by external shocks or friction because the surface of the display is exposed to the outside, and the surface of the touch screen of the display device is frequently scratched by foreign substances stained on a user's finger or a touch pen because the user directly touches the screen with the finger or the touch pen.

Accordingly, in order to solve the above problem, adhesive thin films made of synthetic resin adhered on the surface of the screen of the display device or thin films made of synthetic resin with static cling is coated on the surface of the screen have been used.

Such protective films can be firmly adhered or coated on the display device only when a portion of the protective film is first adhered or coated on the surface of the screen in close contact and the entire of the protective film is slowly adhered or coated on the surface of the screen in order in such a way not to form air gaps between the protective film and the surface of the display screen. However, such work is complicated and inconvenient and the protective films deteriorate visibility of the display device because it is difficult to completely remove the air gaps.

Furthermore, if the user repeatedly adhere and remove the protective film in order to perfectly cover the surface of the display screen with the protective film without any problem, because fingerprints or other foreign substances are stained on an adhesive face of the protective film, adhesive force of the protective film is deteriorated and the protective film adhered or coated on the display screen may be partially peeled up.

Moreover, the conventional protective films can prevent scratches formed on the display device, but cannot prevent damages of the display device occurring when external shocks are transferred to the display device. Additionally, the conventional protective films has another problem in that the adhered or coated protective film is peeled up from the display device because its adhesive force becomes weak starting from corner portions or an outer edge portion when as time passes.

That is, the conventional protective films are made of a soft material with flexibility and bendability and adhered on the surface of the display device in close contact, but the protective film is peeled up starting from the outer edge or the corners thereof and adhesive force of the protective film is deteriorated because the protective film is hardened and adhesive ingredients are volatilized or an amount of static electricity is reduced as time passes, and hence, the protective film is not reusable and limited in its lifespan.

### SUMMARY OF THE INVENTION

Accordingly, the present invention has been made to solve the above-mentioned problems occurring in the prior arts, and it is an object of the present invention to provide an LCD screen protector for LCD devices, which is a protective plate made of tempered glass or reinforced plastics with excellent strength and surface hardness and is easily adhered on a screen of the display device to protect the surface of the display device.

Moreover, it is another object of the present invention to provide an LCD screen protector for LCD devices, which includes a shock absorbing layer disposed between the LCD screen protector and the surface of the display device, thereby preventing scratches of the display device by the LCD screen protector with excellent surface hardness and absorbing external shocks by the shock absorbing layer.

To accomplish the above object, according to the present invention, there is provided an LCD screen protector for LCD devices comprising: a protective plate made of tempered glass or reinforced plastics with good surface hardness and strength; a ring-shaped band made of a soft material with elasticity and protrudingly formed on the outer circumference of the protective plate; and a hollow portion formed inside the protective plate by the protrudingly formed ring-shaped band, wherein when a user presses the outside of the protective plate in a state where the ring-shaped band is in close contact with the surface of a display device, the air of the hollow portion is moved outwardly and the hollow portion can keep a vacuum condition because the air pressure of the hollow portion formed between the protective plate and the display device is lower than the air pressure of the outside air of the absorbing plate to thereby stably attach the protective plate to the display device.

The LCD screen protector according to the present invention can prevent scratches during the use of the display device and provide durability because the protective plate has good surface hardness and strength.

Moreover, because the absorbing plate is formed on an end portion of the ring-shaped band, the LCD screen protector is more stably attached to the display device by virtue of absorptive power of the absorbing plate and vacuum strength of the hollow portion, whereby the present invention can prevent the LCD screen protector from being peeled up during the use, prevent deterioration of adhesive force even though the screen protector is repeatedly adhered and removed, and allow the user to adhere the screen protector on a correct position of the display device since the screen protector is in a plate form.

Furthermore, the LCD screen protector can minimize external shocks transferred to the display device and prevent damages of the display device caused by the external shocks because the LCD screen protector and the display device are adhered with each other through the ring-shaped band with elasticity and the hollow portion is formed between the screen protector and the display device.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a perspective view of an LCD screen protector for LCD devices according to the present invention;

FIG. 2 is a sectional view of the LCD screen protector;

FIGS. 3(a) and 3(b) are enlarged views of a part A of FIG. 2, showing an example of an absorbing part, which is an essential part of the present invention;

FIG. 4 is a view showing an example of adhesion of the LCD screen protector onto the LCD device;

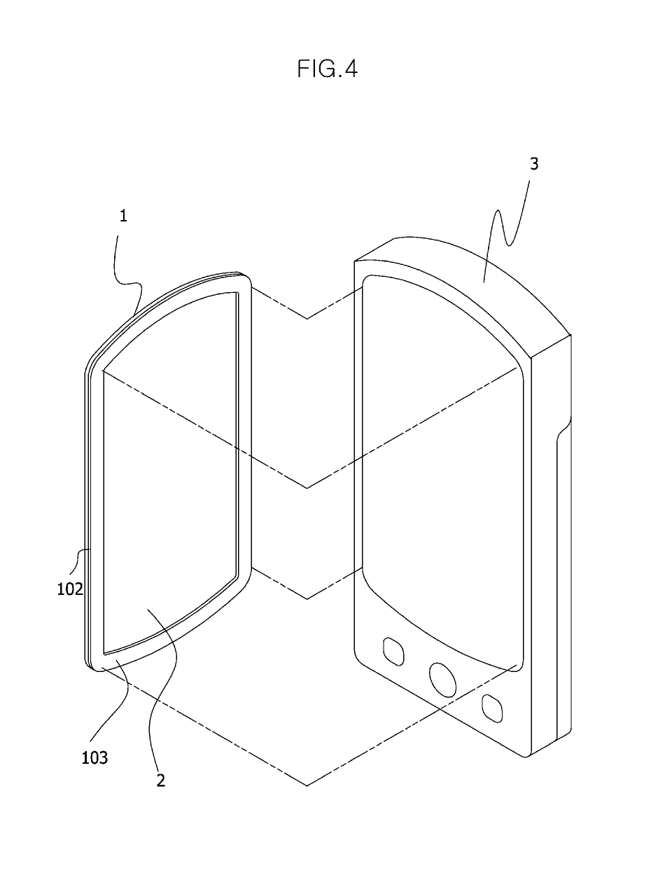

FIG. 5 is an exemplary view of the LCD screen protector adhered on the LCD device; and

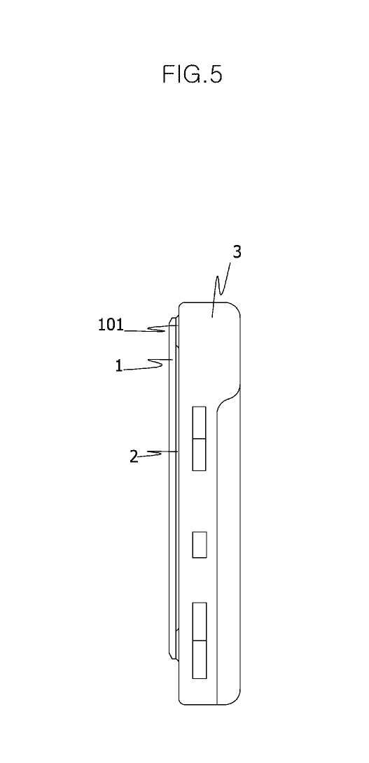

FIG. 6 is an exemplary view of an absorbing part formed at a position corresponding to a sending and receiving hole of the LCD device.

### DETAILED DESCRIPTION OF THE PREFERRED EMBODIMENT

Reference will be now made in detail to the preferred embodiment of the present invention with reference to the attached drawings.

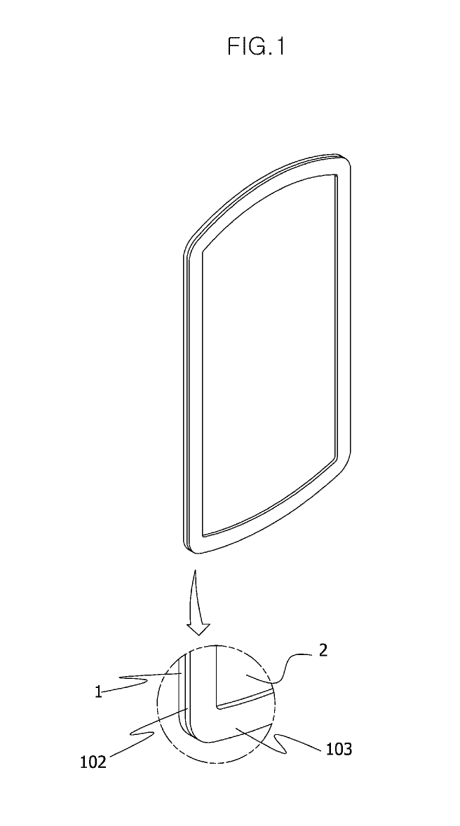

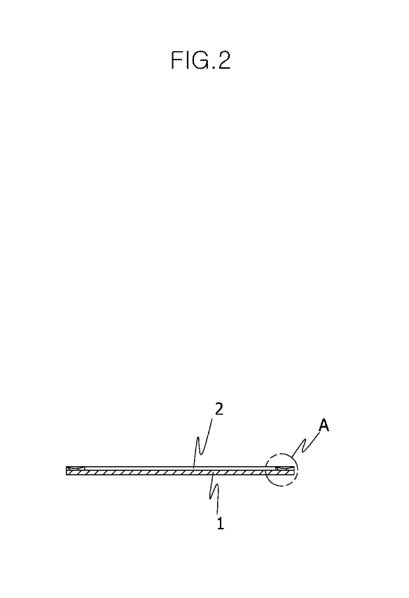

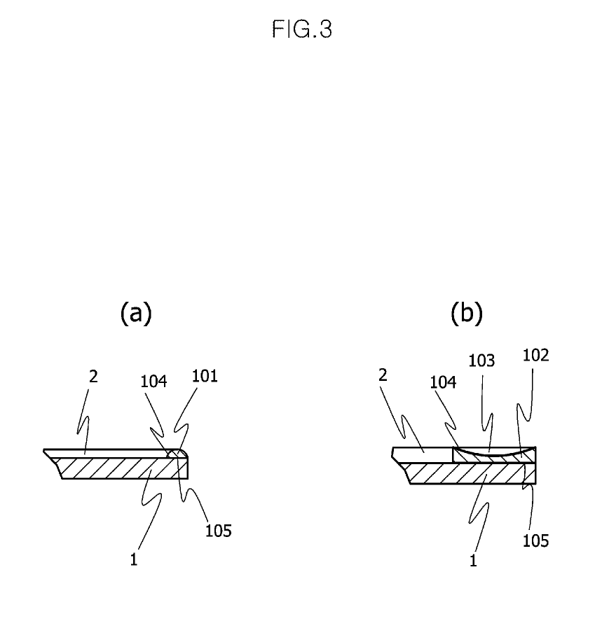

FIGS. 1 and 2 are a perspective view and a sectional view of an LCD screen protector according to the present invention, and FIG. 3 is an enlarged sectional view of an absorbing part, which is an essential part of the present invention.

The LCD screen protector according to the present invention includes a protective plate 1 made of tempered glass or reinforced plastics with good anti-bendability and a ring-shaped band 101 with elasticity protrudingly formed on an outer circumference of the protective plate 1.

Alternatively, the ring-shaped band 101 may be an absorbing plate 102, which has an absorbing groove 103 formed at the center of the absorbing plate 102 and protrudes from the surface of the protective plate 1. The protective plate 1, which is made of a transparent material, has a patterned layer formed on an outer edge portion thereof, so that the ring-shaped band or the absorbing plate is hidden by the patterned layer.

The absorbing plate 103 is made of a soft material, such as urethane, and has the absorbing groove 103 where the center is lower than outer portions.

Hereinafter, the process to adhere the LCD screen protector to the display device will be described.

First, as shown in FIG. 3(a), when a user presses an outer face of the protective plate 1 in such a way that a hollow portion 2 formed inside the screen protector by the ring-shaped band 101 is compressed in a state where the ring-shaped band 1 of the screen protector is in close contact with the display device 3, the ring-shaped-band 101 is pressed down and, at the same time, the inside air of the hollow portion 2 is moved to the outside of the ring-shaped band, namely to the outside of the hollow portion. After that, when the pressure applied to the protective plate 1 is removed, the hollow portion 2 of the screen protector keeps a vacuum condition that the atmospheric pressure is lower than the outside because the outside air is not introduced into the hollow portion 2 by virtue of the ring-shaped band 101.

In this instance, even though ring-shaped band 101 tries to restore to its original condition, the ring-shaped band 101 keeps the vacuum condition of the hollow portion 2 in close contact with the surface of the display device 3 because the absorptive power of the screen protector is stronger than the restoring force.

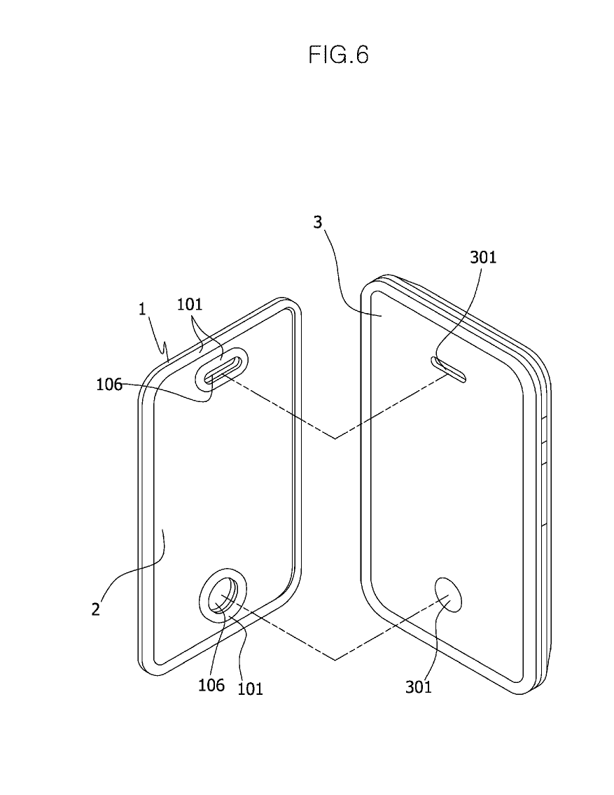

It is possible to keep sealability between the sending and receiving hole 301 of the display device 3, which is located within an adhesion range of the screen protector, and the hollow portion 2 because the protective plate 1 includes a through hole 106 and a ring-shaped band 101 disposed on the circumference of the through hole as shown in FIG. 6.

Accordingly, the protective plate 1 is adhered and fastened to the display device 3.

Moreover, as shown in FIG. 3(b), in place of the ring-shaped band 101, the absorbing plate 102 having the absorbing groove 103, in which the center is lower than the outer portions, is located on the protective plate 1. When the user presses the outer face of the protective plate 1 where the absorbing plate 102 is located in a state where the absorbing plate 102 is in close contact with the display device 3, the ring-shaped-band 101 is pressed down and, at the same time, the air located inside the absorbing groove 103 is moved outwardly to thereby keep a vacuum condition, so that the LCD screen protector can be adhered on the display device 3.

Therefore, the LCD screen protector can be adhered on the display device through the absorbing plate 102, and additionally, when the user presses the hollow portion 2 formed inside the absorbing plate 102, the hollow portion 2 is in the vacuum condition, and hence, the LCD screen protector can be stably adhered on the display device by virtue of the absorptive force of the absorbing plate 102 and the vacuum condition of the hollow portion 2.

In the meantime, adhesive material 104 is coated on the surface of the ring-shaped band 101 and the absorbing groove 103 of the absorbing plate 102 to adhere the ring-shaped band 101 and the absorbing plate 102 to the display device 3, whereby the absorbing plate 102 can have an improved absorptive power and sealability between the hollow portion 2 and the display device 3 can be kept more stably. The protective plate 1 has the patterned layer 105 formed on the outer circumference thereof corresponding to the position of the ring-shaped band, so that the ring-shaped band 101 is hidden by the patterned layer 105.

While the present invention has been described with reference to the particular illustrative embodiment, it is not to be restricted by the embodiment but only by the appended claims. It is to be appreciated that those skilled in the art can change or modify the embodiment without departing from the scope and spirit of the present invention.

What is claimed is:

1. An LCD screen protector for LCD devices comprising:
a protective plate (1) made of tempered glass or reinforced plastics;
a ring-shaped band (101) with elasticity protrudingly formed on the outer circumference of the protective plate (1); and
a hollow portion formed inside the protective plate by the protrudingly formed ring-shaped band,
wherein when a user presses the outside of the protective plate (1) in a state where the ring-shaped band (101) is in close contact with a display device (3), the hollow portion (2) is also pressed, so that the hollow portion can keep a vacuum condition to thereby stably attach the protective plate to the display device.

2. The LCD screen protector according to claim 1, wherein the ring-shaped band (101) is an absorbing plate (102) having an absorbing groove (103) formed at the inner central portion thereof.

3. The LCD screen protector according to claim 1, wherein adhesive material (104) is coated on the surface of the ring-shaped band (101).

4. The LCD screen protector according to claim 1, wherein the protective plate has a patterned layer formed on the outer circumference thereof and the ring-shaped band is disposed in such a way as to be hidden by the patterned layer.
